(19) United States
(12) Patent Application Publication
(10) Pub. No.: US 2007/0200998 A1
(43) Pub. Date: Aug. 30, 2007

(54) LED ILLUMINATED NOVELTY GLASSES

(75) Inventors: Michael L. Schrimmer, Vernon Hills, IL (US); Ronald E. Gilley, Winnetka, IL (US)

Correspondence Address: LEVENFELD PEARLSTEIN;Intellectual Property Department, 2 North LaSalle, Suite 1300, CHICAGO, IL, 60602, US

(73) Assignee: CHEMICAL LIGHT, INC., Vernon Hills, IL (US)

(21) Appl. No.: 11/307,846

(22) Filed: Feb. 24, 2006

(51) Int. Cl. G02C 1/00

(52) U.S. Cl. 351/158

(57) ABSTRACT

Illuminated novelty eye glasses include a frame having a body with portions that define lens openings and adjacent hinge regions, and a bridge region between the portions defining the lens openings. The body has a channel formed therein traversing around the lens openings and across the bridge region. The body is formed from a transparent or translucent material. Ear pieces are connected to the frame at the hinge regions. The ear pieces each have a hinge region for hingedly connecting the ear pieces to the body such that the ear pieces fold inwardly toward the body. The ear pieces each include a compartment and a channel extending generally from the compartment to the hinge region. An LED assembly is formed from a plurality of light emitting diodes mounted to a plurality of conductors. A power source is operably connected to the LED assembly and is carried in one of the ear piece compartments and a switch operably connects the power source to the LED assembly and is carried in the other ear piece compartment. The LED assembly is disposed in the channel in the frame and in the ear pieces and the light emitting diodes are illuminated by actuation of the switch. Light from the light emitting diodes is transmitted by the diodes and is visible through the frame and ear pieces.

### BACKGROUND OF THE INVENTION

The present invention is directed to a novelty device. More specifically, the present invention is directed to a LED illuminated glasses novelty device.

Novelty devices come in all manner, shape and size. Illuminated devices are typically more interesting and attraction-grabbing in that one's eyes are, by instinct, drawn to a lighted object. This is even more so when the lights (illumination) is colored and/or on and off in, for example, a blinking fashion.

Many types of glasses are popular as novelty devices. This is particularly true with colored glasses (frames and/or lenses) and other, unusual glasses characteristics. Many types and styles of sunglasses are also quite popular, particularly with younger individuals.

Glasses have become a novelty item with respect to how they can transform or change an individual's appearance. This in one reason that glasses have transitioned from merely functioning as corrective lenses to becoming an accessory item.

One type of novelty glasses are lighted or illuminated glasses. These glasses typically have one or more bulbs mounted to the frames. An external power source, such as a battery pack, is tethered to the glasses frames and is carried on, for example, the wearer's belt. While this arrangement does provide the novelty of “lighted glasses” it is cumbersome in that a separate battery pack is needed and the battery pack is connected to the glasses by an exposed wire or conductor.

Accordingly, there is a need for a high quality novelty lighted glasses device. Desirably, such glasses have a compact power source. More desirably, such glasses have a power source configured to eliminate exposed wires.

### BRIEF SUMMARY OF THE INVENTION

Illuminated novelty eye glasses include a frame having a body having portions that define lens openings with adjacent hinge regions, and a bridge region between the lens openings. The body has a channel formed therein that traverses around the lens openings and across the bridge region. The body is formed from a transparent or translucent material. The body can be colored.

The frame also includes ear pieces that are connected to the body at the hinge regions. Each ear piece has a hinge region for connecting the ear pieces to the frame such that the ear pieces fold inwardly toward the frame. The ear pieces include a compartment and a channel formed therein that extends generally from the compartment to the hinge region. The ear pieces can also be formed from a transparent or translucent material.

An LED assembly includes a plurality of light emitting diodes and a plurality of conductors. The diodes are mounted to the conductors spaced from one another along the length of the conductors.

A power source is operably connected to the LED assembly and is carried in one of the ear piece compartments. A switch operably connects the power source to the LED assembly and is carried in the other compartment.

The LED assembly is disposed in the channels in the frame 9the body and ear pieces). The diodes are illuminated by actuation of the switch, and light from the diodes is visible through the frame.

The ear piece compartments include covers. Preferably, the covers are removable. The switch is disposed such that a portion of the switch extends outward from the compartment wall to change the state of the switch (i.e., switch the LEDs on and off).

In present glasses, a cover overlies the channels in the body and the ear pieces. The cover is formed from a resilient material, such as rubber, neoprene or the like. The cover can be pressed into (e.g., press-fit in) the channel to secure the cover in place. The cover can also be secured in place by a small amount of adhesive.

The LED assembly can include circuitry for illuminating the light emitting diodes at certain predetermined times and intervals, such as in a flashing scheme or in a continuous on lighting scheme.

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a perspective view of LED illuminated glasses embodying the principles of the present invention;

FIG. 2 is a perspective view similar to FIG. 1, showing the LED assembly components of the glasses in phantom lines;

FIG. 3 is perspective view similar to FIG. 1, showing the LED assembly components in an exploded perspective; and

FIG. 4 is an exploded view of the glasses power source and housing.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description Of The Invention”, relates to a requirement of the United States Patent Office, and does not imply, nor should be inferred to limit the subject matter disclosed herein.

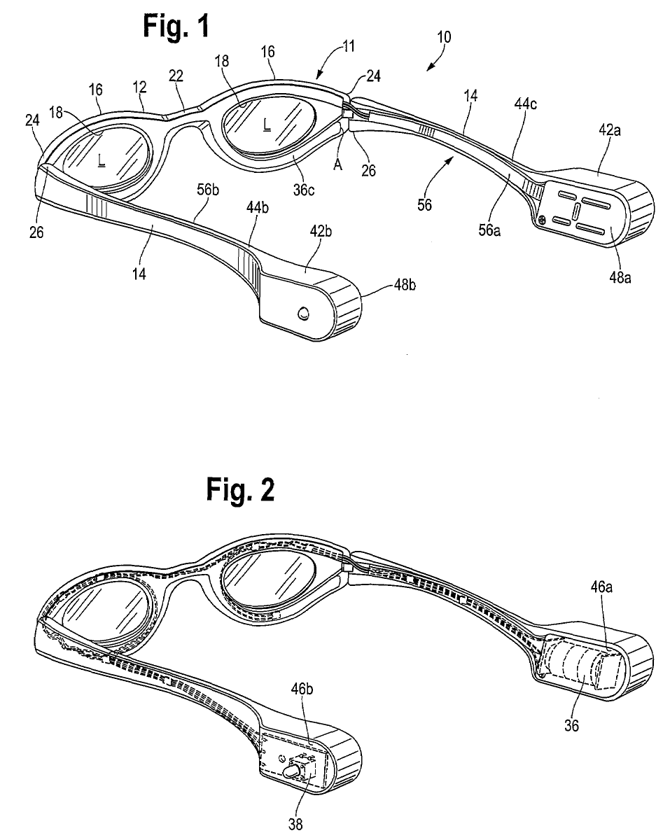

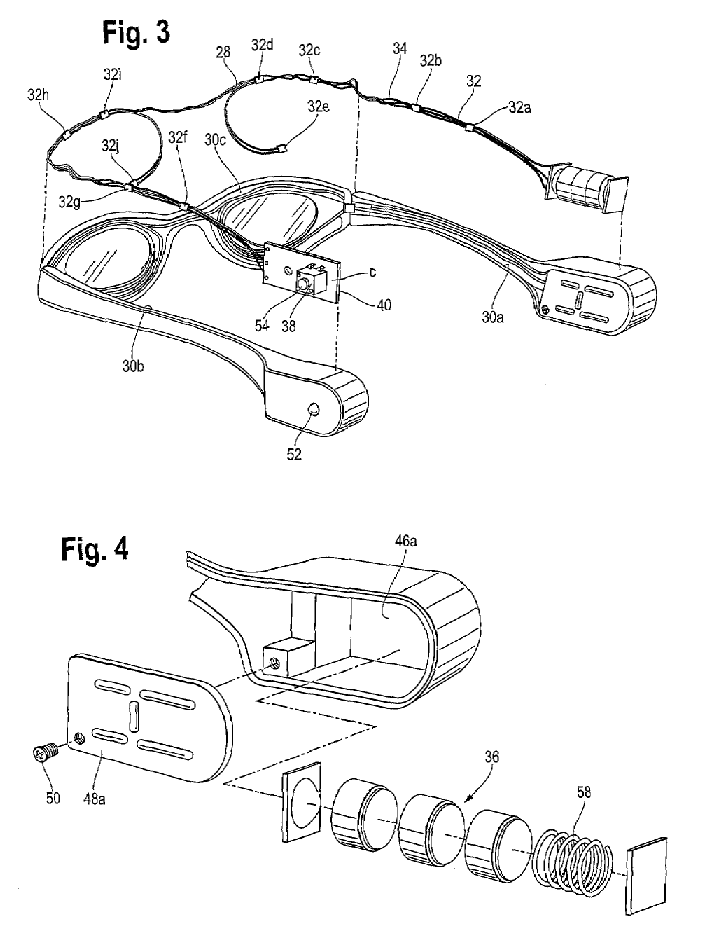

Referring now to the figures, and in particular to FIG. 1, there is shown LED illuminated glasses 10 embodying the principles of the present invention. The glasses 10 are configured as conventional glasses, having a frame 11 having a body 12 and a pair of ear pieces 14 that preferably fold in toward the body 12. The body 12 has elements or portions 16 that define openings 18 for lenses L and a bridge 22 connecting the portions 16 that define the openings 18. Hinges 24 are formed at the ends of the body 12 for hingedly mounting the ear pieces 14 to the body 12. The earpieces 14, likewise, have hinge regions 26 to mount to the body hinges 24.

The frame 11 (e.g., the body 12 and ear pieces 14) is formed from a transparent or translucent material such that the light emitted from the LEDs is visible through the frame. The material, which in a present glasses is a plastic material, can be colored to provide a different aesthetic effect.

The glasses 10 include an LED assembly 28 that, as will be discussed below, is fitted into channels 30a, 30b and 30c (collectively 30) in the ear pieces 14 and body 12, respectively. The LED assembly 28 is an elongated element having multiple LEDs 32a-j (collectively, 32) connected to one another both electrically and physically by conductors 34. The assembly 28 includes a power source 36 such as the illustrated batteries, and a switch 38 to actuate the LED assembly 28 (to illuminate the LEDs 32). The switch 38 is mounted to a circuit board 40 (that contains circuitry C) for controlling the illumination scheme of the LEDs 32.

To house the circuit board 40 and switch 38, as well as the batteries 36, the frame 11 includes extensions 42a,b that extend from the rear 44 of the ear pieces 14. One of the extensions 42a includes the batteries 36 in a covered compartment 46a. A cover 48a is held on the compartment 46a by a fastener 50, such as the illustrated threaded fastener.

The opposing extension 42b also forms a compartment 46b that houses the circuit board 40 (which has the switch 38 mounted thereto). The compartment 46b is also covered by a cover 48b. The compartment 46b includes an opening 52 through which the switch button 54 extends, to actuate the LED assembly 28. Unlike known “lighted” glasses, which require a separate power source, such as a battery that is worn on a lanyard or on a belt, the present glasses are fully self-contained. That is, the power source (batteries 36), switch 38 and circuitry C are all contained within the glasses frame 11. In this manner, there are no dangling (exposed) wires or cumbersome battery packs, but only a sleek looking glasses frame 11.

To accommodate the conductors 34 and the LEDs 32 in a protected manner, the ear pieces 14 and the body 12 include the aforementioned channels 30a-c formed in an inner surface of each of the elements 12, 14. The channels 30a,b in the ear pieces 14 extend from the extensions 42a,b (running in to the compartments 46a,b, below the covers 48a,b) to the hinge ends 26 and in the body 12, from the hinge ends 24, around each of the lens openings 18 and into the bridge 22, such that the body channel 30c is a continuous channel (with loops or branches) and is contiguous with the ear piece channels 30a,b. At the hinges 24, 26, the ear piece channels 30a,b and the body channel 30c are in confronting relation so that even though the conductors 34 may be exposed when the ear pieces 14 are folded in, the conductors 34 are maintained between the confronting channels 30a, 30c and 30b, 30c. In such an arrangement, because the conductors 34 are in an interior portion of the folded glasses 10, they are protected from possible damage by bumping, pulling or contact with a foreign object.

The LED assembly 28 is laid in the channels 30a-c essentially to protect the conductors 34 from damage. To maintain the LED assembly 28 in the channels 30a-c, a flexible cover 56 (formed as portions 56a, 56b, 56c) is positioned on, and at least in part, in, the respective channel portions 30a-c. The covers 56 extend over the channels 30a-c around the lens openings 18, across the bridge 22 and along the ear pieces 14. In a present frame 11, the cover 56 is a rubber or elastic material. Rubber is preferred in that it is resilient and flexible and has a high friction coefficient and thus remains in place in the channels 30a-c. A light coat of an adhesive A can also be used to further maintain the covers 56a-c in the channels 30a-c to protect the conductors 34.

Those skilled in the art will recognize that there are a relatively large number of types of LEDs 32 currently available. The present glasses 10 use a plurality of miniature or subminiature LEDs so that the frame 11 (the body 12 and ear pieces 14) can remain a relatively conventional size.

The batteries 36 are housed in the compartment 46a in a biased (spring 58 held) arrangement. The spring 58 arrangement holds the batteries 36 in the compartment 46a in a substantially secure manner while at the same permitting ready access to the batteries 36 (by removing the cover 48a) for replacement.

To facilitate manufacture and assembly, the LED assembly 28 is constructed so that the conductors 34 and the LEDs 32 are provided or fabricated as a linear or near linear (e.g., partially branched) assembly in a flexible or bendable manner. The LED assembly 28 is laid in the channels 30a-c and the covers 56a-c are inserted into the channels 30a-c (if desired with the adhesive A).

In present glasses 10, the assembly 28 includes ten LEDs 32a-j, which can be the same or different colors. The assembly 28 can be configured (by the circuitry C on the circuit board 40) to provide a number of different lighting schemes. For example, the assembly 28 can be configured to provide a flashing scheme and/or an “on” or lighted scheme. Other lighting schemes can include, for example, a one-direction sequential flashing scheme.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover all such modifications as fall within the scope of the disclosed, exemplary embodiment.

What is claimed is:

1. An illuminated novelty eye glasses comprising:
a glasses body having portions that define lens openings and adjacent hinges regions, the body having a bridge region between the portions defining the lens openings, the body having a channel formed therein traversing around the lens openings and across the bridge region, the body formed from a transparent or translucent material;
ear pieces connected to the body at the hinge regions, the ear pieces each having a hinge region for hingedly connecting the ear pieces to the body such that the ear pieces fold inwardly toward the body, the ear pieces each including a compartment and each including a channel formed therein extending generally from the compartment to the hinge region;
a plurality of light emitting diodes;
a plurality of conductors, the light emitting diodes mounted to the conductors spaced from one another along the length of the conductors, the light emitting diodes and the conductors defining an LED assembly;
a power source operably connected to the LED assembly, the power source carried in one of the ear piece compartments; and
a switch operably connecting the power source to the LED assembly, the switch carried in the other of the ear piece compartments,
wherein the LED assembly is disposed in the channels in the body and in the ear pieces and wherein the light emitting diodes are illuminated by actuation of the switch, and wherein light from the light emitting diodes is transmitted by the diodes and is visible through the body.

2. The illuminated novelty eye glasses in accordance with claim 1 wherein the ear pieces are formed from a transparent or translucent material.

3. The illuminated novelty eye glasses in accordance with claim 1 wherein the compartments include covers.

4. The illuminated novelty eye glasses in accordance with claim 3 wherein the cover over the battery compartment is removable.

5. The illuminated novelty eye glasses in accordance with claim 1 wherein the switch is disposed such that a portion of the switch extends outward therefrom for changing a state of the switch.

6. The illuminated novelty eye glasses in accordance with claim 1 including a cover overlying the channel in the frame.

7. The illuminated novelty eye glasses in accordance with claim 1 including a cover overlying the channels in the ear pieces.

8. The illuminated novelty eye glasses in accordance with claim 6 including a cover overlying the channels in the ear pieces.

9. The illuminated novelty eye glasses in accordance with claim 6 wherein the cover is formed from a resilient material.

10. The illuminated novelty eye glasses in accordance with claim 9 wherein the cover is pressed into the channel.

11. The illuminated novelty eye glasses in accordance with claim 9 wherein the cover is secured in place over the channel by an adhesive.

12. The illuminated novelty eye glasses in accordance with claim 1including circuitry for illuminating the light emitting diodes at certain predetermined times and intervals.

13. The illuminated novelty eye glasses in accordance with claim 12 wherein the circuitry is carried on a circuit board.

14. The illuminated novelty eye glasses in accordance with claim 12 wherein the light emitting diodes are illuminated in a flashing scheme.

15. The illuminated novelty eye glasses in accordance with claim 15 wherein the light emitting diodes are illuminated in a continuous on lighting scheme.
